(19) United States
(12) Patent Application Publication
(10) Pub. No.: US 2008/0171242 A1
(43) Pub. Date: Jul. 17, 2008

(54) Reformer, Method for Controlling Pump in Fuel Cell System, and Control Unit

(76) Inventor: Kazuhiro Osada, Aichi (JP)

Correspondence Address: KENYON & KENYON LLP, 1500 K STREET N.W., SUITE 700, WASHINGTON, DC, 20005, US

(21) Appl. No.: 11/885,397

(22) PCT Filed: May 10, 2006
(86) PCT No.: PCT/JP06/09778

§ 371 Date: Aug. 30, 2007

(30) Foreign Application Priority Data
May 11, 2005 (JP) 2005-138380
May 9, 2006 (JP) 2006-129743

(51) Int. Cl. H01M 8/18; H01M 8/00

(52) U.S. Cl. 429/17; 429/20

(57) ABSTRACT

An object is to provide a reformer, a method for controlling a natural gas pump in a fuel cell system, and others, capable of selectively changing a flow rate between for system start-up and for normal operation thereof. In the method for controlling a natural gas pump in the fuel cell system comprising a reforming unit, a combustion unit, a fuel supply unit, a fuel pump for combustion; a fuel pump for reforming, and a first shutoff valve placed in a second fuel line, the reformer of the invention comprises a bypass line that connects the first fuel line to the second fuel line.

This is a 371 national phase application of PCT/JP2006/309778 filed 10 May 2006, claiming priority to Japanese Applications No. 2005-138380 filed 11 May 2005, and No. 2006-129743, filed 9 May 2006, the contents of which are incorporated herein by reference.

### FIELD OF THE INVENTION

The present invention relates to a method for controlling a fuel cell system to reform fuel such as natural gas, propane gas, and the like to generate hydrogen, and a control unit.

### BACKGROUND OF THE INVENTION

A hydrogen-oxygen fuel cell exists as one of chemical cells and is now studied energetically as a main candidate of a future effective electric power source since clean and highly efficient electric power generation can be obtained with the hydrogen-oxygen fuel cell. The hydrogen-oxygen fuel cell uses hydrogen as the fuel and, as a means for obtaining such hydrogen, there is a fuel cell system for reforming fuel such as natural gas to generate hydrogen.

Such a fuel cell system generates hydrogen by reforming reaction caused by: using, for example, natural gas and water as the raw materials; removing sulfur compounds before reformed; and putting the raw materials in touch with a reforming catalyst. However, the reforming reaction is an endothermal reaction and hence the reforming catalyst has to be heated when the fuel cell system is operated. In addition, it is also necessary to secure a certain heat quantity in order to start the reaction when the operation starts.

Here, a method for efficiently heating a reforming catalyst is disclosed, for example, in Patent Document 1.

FIG. 6 is a configuration diagram of a fuel cell electric power generation system to which a fuel reformer for reforming fuel such as methanol or the like to generate hydrogen is applied, as shown in Patent Document 1.

The structure of the fuel cell electric power generation system having the fuel reformer for reforming fuel such as methanol or the like to generate hydrogen is quite similar to the structure of a fuel cell electric power generation system having a fuel reformer for reforming fuel such as natural gas or the like and generates hydrogen.

The fuel cell electric power generation system shown in FIG. 6 includes a fuel cell 140 and a fuel reformer 110 for generating hydrogen as gaseous fuel to be supplied to the fuel cell 140. The fuel reformer 110 comprises a vaporizer 111 to vaporize liquid fuel and a fuel reforming unit 109 to reform gaseous fuel coming from the vaporizer 111.

The fuel cell 140 is provided with: a fuel electrode 142 and an air electrode 143 in the manner of interposing an electrolyte 141; and further a heat exchanger 144 for cooling the fuel cell 140. A reformed gas line 103 to supply the gaseous fuel and an off gas line 105 to discharge an exhaust gas generated from the fuel electrode 142 are connected to the fuel electrode 142. Meanwhile, a line to supply air containing an oxygen as an oxidizing agent (not shown) is connected to the air electrode 143. The reformed gas line 103 and the off gas line 105 are connected to the respective connectors of the fuel reforming unit 109. The fuel reforming unit 109, the details of which will be described later, is provided with many heat exchangers each of which having a combustion catalyst layer on a side connected to the exhaust gas passage and a reforming catalyst layer on another side connected to the gaseous fuel passage, respectively.

Further, the fuel cell electric power generation system is provided with a vaporizer 111 and a burner 112. Then the fuel reforming unit 109 takes the gaseous fuel coming from the vaporizer 111 into the side connected to the gaseous fuel passage and also takes the combustion heat gas supplied through the off gas line 105 into the side connected to the combustion heat gas passage. Then the gaseous fuel is reformed with the heat generated in the combustion catalyst layers and the function of the reforming catalyst layers and is sent to the reformed gas line 103.

A fuel tank 115 is connected to the vaporizer 111 via a pump 113. Then the fuel stored in the fuel tank 115 is supplied to the vaporizer 111 by the pump 113(a) and the vaporizer 111 supplies the fuel to the fuel reforming unit 109 as gaseous fuel by the combustion heat of the burner 112.

The fuel reforming unit 109: takes the gaseous fuel coming from the vaporizer 111 into each of the reforming catalyst layers; introduces the gaseous fuel (methanol) and air into the combustion heat gas supplied via the off gas line 105; and introduces the gas as combustion gas into each fuel catalyst layer.

By warming the fuel reforming unit 109 and the vaporizer 111 by the burner 112 supplied with fuel from the fuel tank 115 through the pump 113(c), as mentioned above, the heat quantity required for the reforming reaction is secured.

In Patent Document 1, the fuel reforming unit 109 is further devised and the uniformity of heat generation in the interior of the fuel reforming unit 109 is conditioned by adjusting the concentration of the combustion catalyst in the fuel reforming unit 109.

Further, Patent Document 2 discloses a control system of a fuel cell and shows a method for controlling the pressure-flow rate characteristic of fuel supplied to the fuel cell with high accuracy.

FIG. 7 shows a configuration diagram of a control system for a fuel cell described in Patent Document 2.

A control system 210 of a fuel cell having the shape described in Patent Document 2 comprises: a fuel cell 211; a fuel supply unit 212 to supply liquid fuel comprising, for example, a liquid mixture of methanol and water or the like; a vapor generation unit 213 to generate fuel vapor by vaporizing the liquid fuel; a combustion unit 214 to generate combustion gas used for the warming of the vapor generation unit 213 and the vaporization of the liquid fuel; a reforming unit 215 to generate reformed fuel of hydrogen rich from the fuel vapor; a CO reducer 216 to selectively oxidize and remove carbon monoxide in the reformed fuel; an oxidizing agent supply unit 217 to supply an oxidizing agent such as air or the like to the fuel cell 211; a control unit 218; a discharged fuel flow rate controller 219; a reformed fuel pressure detector 221; a reformed fuel flow rate detector 222; a discharged fuel pressure detector 223; a generated electric current detector 224; an auxiliary fuel supply unit 225; an output controller 226; a small flow rate valve 227 and a large flow rate valve 228 installed in the discharged fuel flow rate controller 219; and a target generated electricity input unit 229.

Then the control system 210 is configured so as to supply fuel to the combustion unit 214 with high accuracy by applying feed forward control and feedback control to the small flow rate valve 227 and the large flow rate valve 228.

Such two valves; the small flow rate valve 227 and the large flow rate valve 228, having pressure-flow rate characteristics different from each other, are provided to execute highly accurate control in the full output ranging from low output to high output while ensuring high responsiveness, and thus to improve electrical efficiency.

Patent Document 1: Japanese Unexamined Patent Application Publication No. 7(1995)-126002

Patent Document 2: Japanese Unexamined Patent Application Publication No. 2001-338671

### SUMMARY OF THE INVENTION

### Problem to be Solved by the Invention

However, in the conventional reformer, when plural pumps are installed, the capacity of each pump has not been used to the maximum. As a result, large pumps have to be used and the first problem has been that a larger reformer must have been used.

Next, the second problem is explained.

In recent years, an attempt to use such a fuel cell system for a household electric power generator has been made and, as a matter of fact, makers have begun to experimentally introduce a fuel cell system as a household electric power generator. Thus, there is the possibility of bearing problems that cannot be solved by the method disclosed in Patent Document 1 or Patent Document 2.

When the fuel cell system is to be used as the household electric power generator in particular, it has to be available for various usage patterns by users. In addition, the cost should be suppressed.

Both the cited documents 1 and 2 are based on the premise that alcoholic fuel such as methanol or the like is used. When the fuel cell system is used as an electric power generator in a house however, it is highly convenient if the electric power generator can be operated with a hydrocarbon gas such as a town gas including a natural gas and so on and a propane gas, those already being prevailing as infrastructure, rather than with an alcoholic liquid.

When it is assumed that a fuel cell system using the hydrocarbon gas as the fuel is applied to household use however, the time required until the fuel cell system becomes ready to generate electricity arises as another problem.

When the fuel is a hydrocarbon gas and the fuel cell system uses a hydrocarbon gas in the state of stopping for a long time as the fuel for reforming, warm-up operation of about one hour is required from the system start-up to the state ready for normal operation. On this occasion, unlike normal operation, the amount of fuel required by a combustion unit is about 20 to 40 times the amount of the fuel required during continuous operation of the system.

The reason is that the electric power generation in a fuel cell is based on chemical reaction and, whereas vaporific reforming can be done at a temperature of 200° C. to 300° C. in the case of an alcoholic fuel (methanol for example) as described in Patent Document 1 and Patent Document 2, a temperature of 600° C. or higher is required particularly in the case of reforming methane or the like contained in a hydrocarbon gas. Once reforming reaction occurs however, although the generated heat quantity is minus in total, heat is generated to some extent and hence only a small quantity of heat is required in the state where the reaction occurs.

That is, although heating to 600° C. or higher is necessary and a lot of fuel is required at system start-up, heat can be supplemented by the reaction during normal operation and hence the amount of fuel used in the combustion unit can be reduced.

Further, the thermal energy required in the combustion unit also varies in accordance with operating conditions.

As a concrete example, when a working couple uses a fuel cell system for electric power generation in a stand-alone house, it is assumed that electricity is scarcely consumed during daytime because they work away from home and after going to bed, and hence electricity is consumed only in the morning and at night.

As stated above, in a time zone where electricity is scarcely consumed, only the least quantity of heat may be required in order to maintain the reaction as long as the amount of generated electricity is small even when heat is supplied continuously.

In the case of a generally used fuel pump in contrast, the usable range of a fuel supply amount is determined from the system configuration. For example, when a pump having the maximum flow rate of 3 L/min is adopted in order to secure a flow rate necessary for the start of the combustion unit, the assured minimum flow rate is about 0.3 L/min and stable supply cannot be obtained at a flow rate lower than that.

However, such a minimum flow rate is insufficient for satisfying the above conditions and the minimum flow rate of 0.1 L/min or less is demanded if energy saving is intended.

That is, when a fuel cell system using natural gas as the fuel is used for household, the flow rate of the fuel necessary for the combustion unit varies largely in accordance with the assumed operating state and therefore the problem here has been that an ordinary pump can hardly cover both the required maximum flow rate and the minimum flow rate.

In the case of such a system as described in the cited document 1, only one fuel pump is installed in order to supply fuel to the combustion unit and hence cannot satisfy the above condition. Further, although the method described in the cited document 2 is effective, such a pump for supplying fuel has high peculiarity and, if the prevalence in household is taken into consideration, it is not preferable to use two fuel pumps in parallel in a fuel supplying route from the viewpoint of cost.

The present invention has been established to solve the above problems and the object thereof is to provide a reformer, a method for controlling a pump in a fuel cell system, and a control unit, which can supply fuel with high accuracy with a simpler configuration.

### Means for Solving the Problem

The reformer according to the present invention has the following configurations.

(1) A reformer comprises: a reforming unit for reforming fuel supplied thereto to generate hydrogen; a combustion unit for combusting fuel supplied thereto to heat the reforming unit; a first fuel pump for compressing and supplying fuel to a first fuel line through which the fuel is to be supplied to the combustion unit; a second fuel pump for compressing and supplying fuel to a second fuel line through which the fuel is to be supplied to the reforming unit; and a bypass line that brings the first fuel line into communication with the second fuel line.

(2) In the reformer set forth in (1), the first fuel pump has a supply capacity smaller than that of the second fuel pump.

(3) In the reformer set forth in (2), the bypass line includes a shutoff valve.

(4) In the reformer set forth in (3), the first fuel pump has a fuel supply capability that allows a minimum amount of fuel required at the combustion unit to be stably supplied when the fuel is reformed at the reforming unit, and the second fuel pump has a fuel supply capability that allows a maximum amount of fuel required at the reforming unit to be stably supplied when the fuel is reformed at the reforming unit.

A method for controlling a pump in a fuel cell system according to the present invention has the following configurations.

(5) In a method for controlling a pump in a fuel cell system comprising: a reforming unit for generating hydrogen from fuel; a combustion unit for combusting the reforming unit; a first fuel pump connected to the combustion unit through a first fuel line, the pump being used for supplying the fuel to the combustion unit; a second fuel pump connected to the reforming unit through a second fuel line, the pump being used for supplying the fuel to the reforming unit; and a first shutoff valve connected to a point of the second fuel line between the reforming unit and the second fuel pump, the system further comprises a bypass line that connects a point of the second fuel line between the first shutoff valve and the second fuel pump to the first fuel line, the method comprises a system start step of closing the first shutoff valve and supplying the fuel to the combustion unit through the bypass line by the second fuel pump at system start-up, and a system operation step of opening the first shutoff valve during operation.

(6) In the method for controlling a pump in a fuel cell system, set forth in (5), the bypass line is provided with a second shutoff valve, and the system start step includes opening the second shutoff valve and the system operation step includes closing the second shutoff valve.

(7) In the method for controlling a pump in a fuel cell system, set forth in (5), the first fuel pump has a fuel supply capability that allows a minimum amount of fuel required at the combustion unit to be stably supplied when the fuel is reformed at the reforming unit, and the second fuel pump has a fuel supply capability that allows a maximum amount of fuel required at the reforming unit to be stably supplied when the fuel is reformed at the reforming unit.

A control unit for a pump in a fuel cell system according to the present invention has the following configurations.

(8) A control unit for a pump in a fuel cell system comprises: a reforming unit for generating hydrogen from fuel; a combustion unit for combusting the reforming unit; a first fuel pump connected to the combustion unit through a first fuel line, the pump being used for supplying the fuel to the combustion unit; a second fuel pump connected to the reforming unit through a second fuel line, the pump being used for supplying the fuel to the reforming unit; and a first shutoff valve connected to a point of the second fuel line between the reforming unit and the second fuel pump, wherein the system further comprises a bypass line that connects a point of the second fuel line between the first shutoff valve and the second fuel pump to the first fuel line, and the first fuel pump has a supply capacity smaller than that of the second fuel pump.

(9) In the control unit for a pump in a fuel cell system set forth in (8), the bypass line includes a second shutoff valve.

(10) In the control unit for a pump in a fuel cell system set forth in (8), the first fuel pump has a fuel supply capability that allows a minimum amount of fuel required at the combustion unit to be stably supplied when the fuel is reformed at the reforming unit, and the second fuel pump has a fuel supply capability that allows a maximum amount of fuel required at the reforming unit to be stably supplied when the fuel is reformed at the reforming unit.

Next, the functions and effects of the reformer, the method for controlling a pump in a fuel cell system, and the control unit having the above configurations are explained.

The bypass line that allows communication between the first fuel line and the second fuel line is provided and hence, when one of the pumps has a reserve capacity, the insufficient capacity of the other pump can be supplemented by raising the output of the pump having the reserve capacity. This makes it possible to supply a large amount of fuel from the second fuel pump at system start-up and a small amount of fuel from the first fuel pump during normal operation.

Accordingly, an excellent effect that a required amount of fuel can always be supplied to the combustion unit by the pumps under the condition that the supply capacities of the two pumps are smaller than those of conventional pumps are obtained.

Further, since the second fuel pump is originally used for supplying fuel to the fuel reformer, it is possible to supply a required amount of fuel by only adding a bypass line without such an additional cost as incurred when a new pump is installed.

Furthermore, since the supply capacity of the first fuel pump is smaller than that of the second fuel pump, the supply capacity of the first fuel pump can be reduced in comparison with the case of independent operation. Here, a compression capability can similarly be used as control means in place of the supply capacity of a pump. That is, the maximum compression capability of the first fuel pump should be smaller than that of the second fuel pump.

In addition, the second shutoff valve is provided in the bypass line, so that the first fuel line can be disconnected from the second fuel line, and hence each pump can be controlled without the influence of the other pump during operation.

When the system starts, the first flow channel to supply fuel to the combustion unit through the bypass line by the second fuel pump is used by closing the first shutoff valve and opening the second shutoff valve. In contrast, during operation, a second flow channel to supply fuel to the combustion unit by the first fuel pump and supply fuel to the reformer with the second fuel pump is used by opening the first shutoff valve, closing the second shutoff valve, and disconnecting the bypass line. As a result, switching the channels allows supply of a large amount of fuel through the second fuel pump at system start-up and supply of a small amount of fuel through the first fuel pump during normal operation.

Consequently, an excellent effect that only a required amount of fuel is always supplied to the combustion unit can be obtained.

Further, the first fuel pump has a fuel supply capability that allows stably supplying a minimum amount of fuel required by the combustion unit when the fuel is reformed in the reformer and the second fuel pump has a fuel supply capability that allows stably supplying a maximum amount of fuel required by the reformer when the fuel is reformed in the reformer. Therefore, the supply capacity of the first pump can be lowered to a fuel supply level that allows stably supplying the minimum amount of fuel required by the combustion unit when the fuel is reformed in the reformer.

Furthermore, at system start-up, since it is not necessary to supply fuel to the reformer, the first fuel pump can be used to supply fuel of an amount necessary for primary combustion. During normal operation, the second pump can be used to supply fuel of an amount necessary for continuous operation. Thus, the system can be operated stably. In addition, it is also possible to stably supply an optimum amount of fuel to the reformer and the combustion unit.

### BRIEF DESCRIPTION OF THE DRAWINGS

FIG. 1 is a diagram showing a method for controlling a natural gas pump in a fuel cell system or a configuration of a reformer in a system of a present embodiment;

FIG. 2 is a diagram showing a configuration of a first flow channel serving as a flow passage used at system start-up in the present embodiment;

FIG. 3 is a diagram showing a configuration of a second flow channel serving as a flow passage used during normal operation in the present embodiment;

FIG. 4 is a flow chart showing a system flow at the start-up in the present embodiment;

FIG. 5 is a diagram showing a configuration of a second embodiment of the present invention;

FIG. 6 is a system configuration diagram of a fuel cell power generation system in Patent Document 1; and

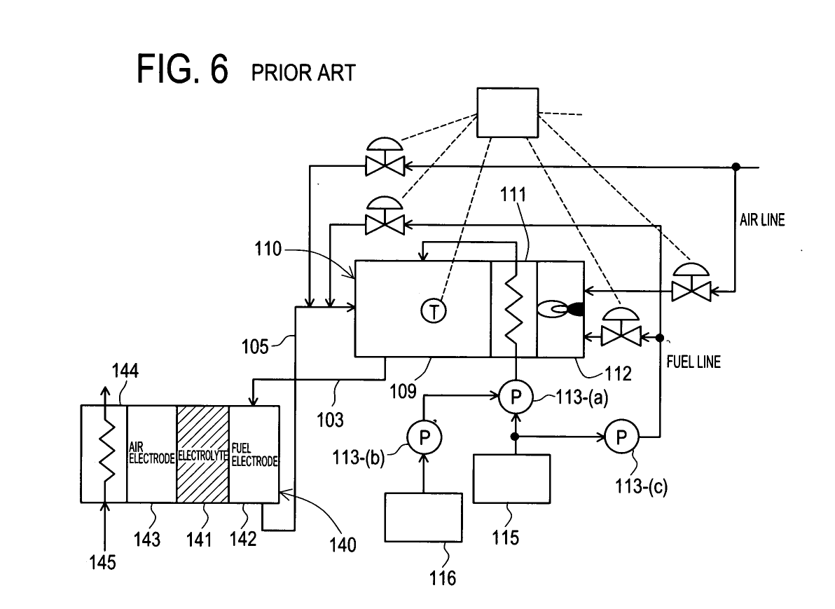

FIG. 7 is a configuration diagram of a control system of a fuel cell in Patent Document 2.

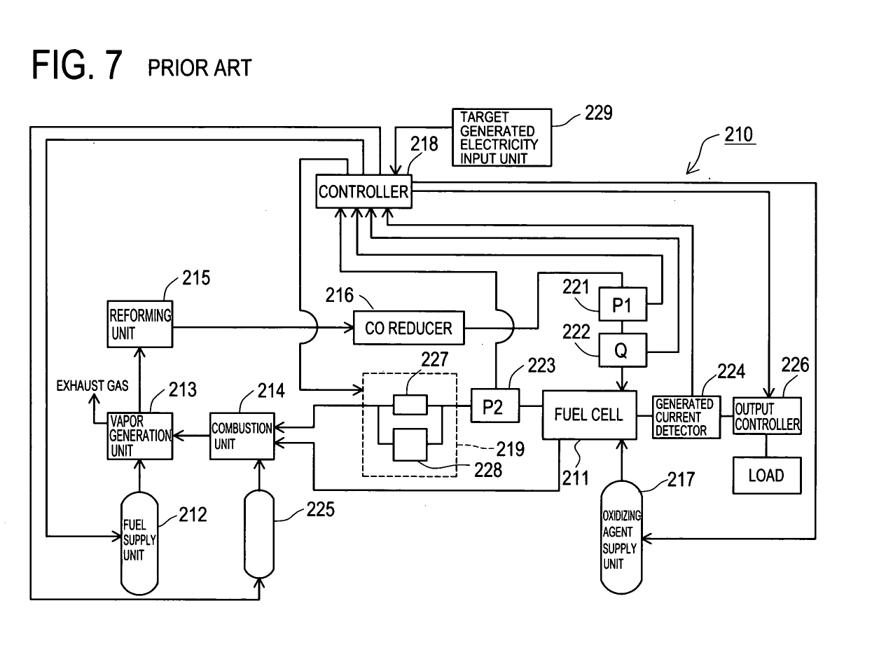

### EXPLANATION OF REFERENCE CODES

10 Fuel reforming system
11 Fuel pump for combustion
12 Fuel pump for reforming
13 Fuel supply unit
14 Fuel gas shutoff valve
15 Second shutoff valve
16 First shutoff valve
17 First fuel line
18 Second fuel line
19 Bypass line
20 Combustion unit
21 Reforming unit
22 Air inlet part
23 Exhaust pipe
24 Stack line

### BEST MODE FOR CARRYING OUT THE INVENTION DETAILED DESCRIPTION

A detailed description of a preferred embodiment of a method for controlling a pump in a fuel cell system and the system embodying the present invention will now be given referring to the accompanying drawings. In the present embodiment, natural gas is used as the fuel.

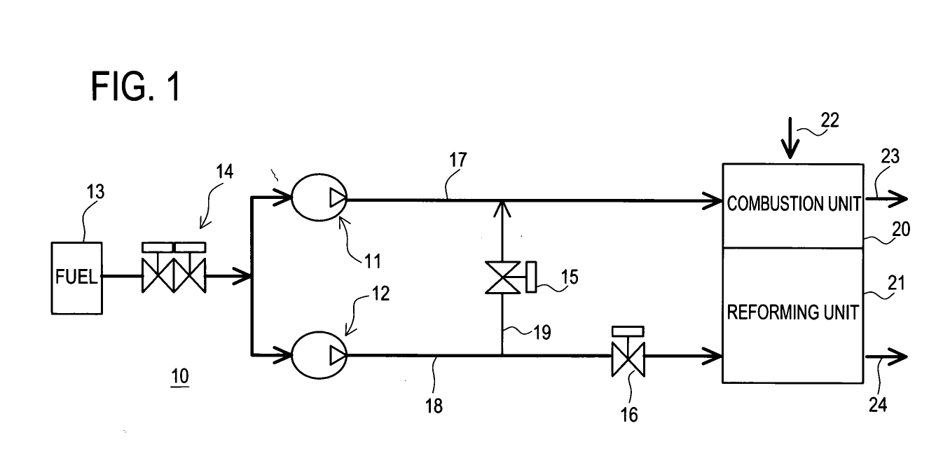

FIG. 1 is a diagram showing the method for controlling a natural gas pump in the fuel cell system or a configuration of a reformer of the system according to the present embodiment.

A fuel reforming system 10 comprises a fuel supply unit 13, a combustion unit 20, and a reforming unit 21 and they are connected to each other with pipes.

A fuel gas shutoff valve 14 (a double valve) is placed at an end of the fuel supply unit 13, and a fuel pump 11 for combustion and a fuel pump 12 for reforming are connected to the other end of the fuel gas shutoff valve 14.

Fuel is supplied to the combustion unit 20 from the fuel supply unit 13 via a first fuel line 17 by the fuel pump 11 for combustion. Fuel is also supplied to the reforming unit 21 from the fuel supply unit 13 via a second fuel line 18 by the fuel pump 12 for reforming. A first shutoff valve 16 is installed in the second fuel line 18.

A bypass line 19 is installed so as to connect the first fuel line 17 to the middle of the second fuel line between the first shutoff valve 16 and the fuel pump 12 for reforming. Then a second shutoff valve 15 is installed in the bypass line 19.

The first fuel line 17 is a line that allows communication between the combustion unit 20 and a fuel supply port for fuel supply (for example, a fuel supply port provided in a building or a supply port of a storage container which stores fuel). The fuel supplied through the fuel supply port is fed to the combustion unit 20 via the first fuel line 17. Further, the second fuel line 18 is a line that allows communication between the reforming unit 21 and a fuel supply port and the fuel supplied through the supply port is fed to the reforming unit 21 via the second fuel line 18.

As the fuel pump 11 for combustion, a pump having the maximum discharge rate of 1 L/min is selected. The fuel pump 11 for combustion has a check valve and can control a flow rate down to about 0.1 L/min at a minimum.

Meanwhile, as the fuel pump 12 for reforming, a pump having the maximum discharge rate of 5 L/min is selected. The fuel pump 12 for reforming has a check valve and can control a flow rate down to about 0.5 L/min at a minimum.

An air inlet part 22 and an exhaust pipe 23 are connected to the combustion unit 20 and the fuel fed from the fuel supply unit 13 is mixed with the air introduced through the air inlet part 22, combusted, and discharged through the exhaust pipe 23.

A stack line 24 is connected to the reforming unit 21 and the fuel gas produced by being reformed from fuel is sent to a fuel cell unit not shown via the stack line 24.

Here, although those are not shown, between the reforming unit 21 and the stack line 24, a shift reaction unit to subject carbon monoxide in the fuel gas produced in the reforming unit 21 to shift reaction and a carbon monoxide reduction unit to reduce the carbon monoxide in the fuel gas discharged from the shift reaction unit are installed. The concentration of carbon monoxide, which poisons the electrode catalyst of the fuel cell, in the fuel gas can be reduced by the shift reaction unit and the carbon monoxide reduction unit. As the carbon monoxide reduction unit, a carbon monoxide selectively oxidizing unit that can selectively oxidize and remove carbon monoxide by supplying a small amount of air may also be used. The carbon monoxide reduction unit may also be substituted with a methanation unit to form methane by reacting carbon monoxide with water.

Such a configuration is represented by the fuel reforming system 10 that is a part of a fuel cell system using natural gas. Then the fuel cell system that additionally comprises a fuel cell unit, a recovered water tank, an evaporator, a condenser, and others, those being not shown and connected to the other end of the stack line 24, is contained in a package so as to be installed at an ordinary household, a small shop, or the like.

Since natural gas or the like is used as the fuel as stated above, the advantage is that the fuel cell system can easily be utilized in an environment where infrastructure such as propane gas, town gas, or the like is well prepared.

Next, the configuration of flow channels is explained.

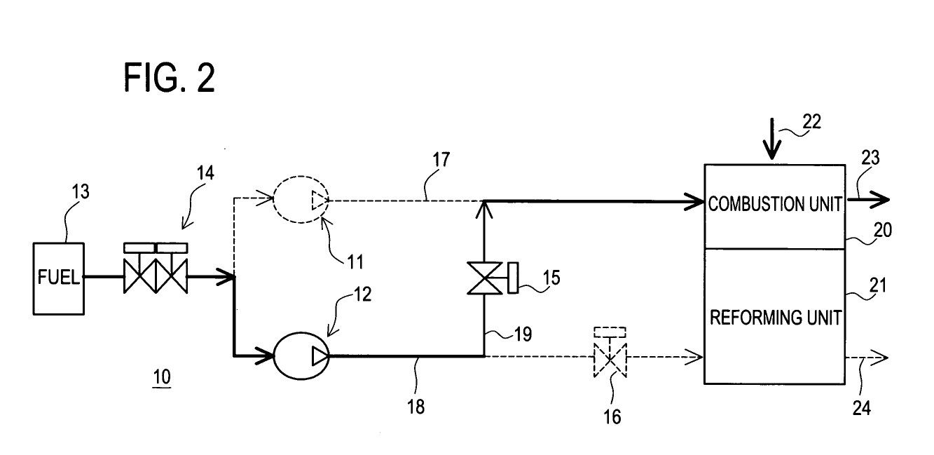

A first flow channel configuration shown in FIG. 2 represents a flow channel at system start-up.

When the system starts, the first shutoff valve 16 is closed and the second shutoff valve 15 is opened. Further, the fuel pump 11 for combustion is not activated and the fuel pump 12 for reforming is activated. Furthermore, the fuel gas shutoff valve 14 is opened.

As a consequence, the fuel is pumped out of the fuel supply unit 13 by the fuel pump 12 for reforming and passes through the second fuel line 18 and the bypass line 19 branching in the middle thereof, leading to the first fuel line 17, and thus the fuel is supplied to the combustion unit 20.

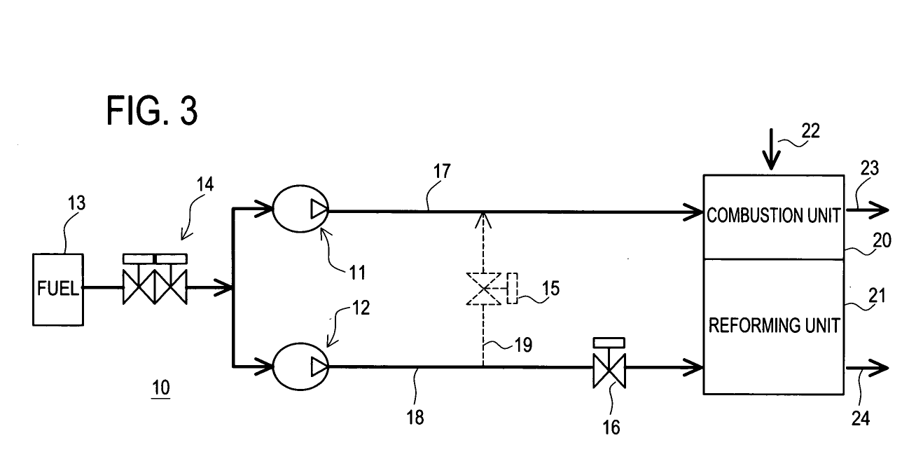

A second flow channel configuration shown in FIG. 3 represents flow channels during normal operation.

During normal operation, the first shutoff valve 16 is opened and the second shutoff valve 15 is closed. Further, the fuel pump 11 for combustion and the fuel pump 12 for reforming are activated and the fuel gas shutoff valve 14 is opened.

As a consequence, the fuel is pumped out of the fuel supply unit 13 by the fuel pump 11 for combustion and passes through the first fuel line 17 into the combustion unit 20. Meanwhile, the fuel is pumped out of the fuel supply unit 13 by the fuel pump 12 for reforming and passes through the second fuel line 18 into the reforming unit 21. On this occasion, since the second shutoff valve 15 is closed, the fuel does not pass between the first fuel line 17 and the second fuel line 18.

The fuel reforming system 10 is configured as stated above, which makes it possible to supply hydrogen to a fuel cell by reforming the fuel.

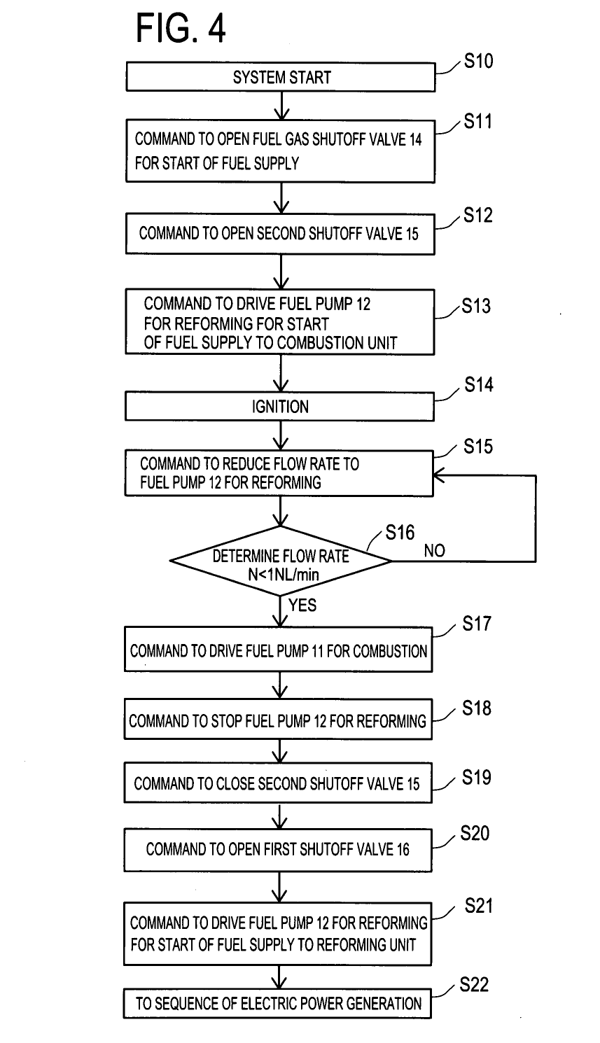

Next, a system flow at start-up is shown in FIG. 4 and the method for controlling the natural gas pump in the fuel cell system and the operations of a control unit at start-up according to the present embodiment are explained.

When the system is activated in step S10, a command to open the fuel gas shutoff valve 14 is issued in step S11, so that the fuel gas shutoff valve 14 is opened and thus the fuel is ready to be supplied. At S12, a command to open the second shutoff valve 15 is issued, so that the second shutoff valve 15 is opened and thus the fuel is ready to pass through the bypass line 19. The state corresponds to the first flow channel configuration shown in FIG. 2, thus the first shutoff valve 16 is closed, and hence the fuel is not supplied to the reforming unit 21.

At S13, a command to drive the fuel pump 12 for reforming is issued and the fuel supply to the combustion unit begins. As stated earlier, the combustion unit 20 requires a large amount of fuel at the start so as to be able to start reaction in the reforming unit 21. Consequently, the fuel can be sent to the combustion unit 20 by the fuel pump 12 for reforming having a large discharge capability.

At S14, an ignition command is issued to the combustion unit 20. On this occasion, the combustion starts in the combustion unit 20, air is taken in through the air inlet part 22, and the gas generated by the combustion is discharged through the exhaust pipe 23.

At S15, a command to reduce the flow rate is issued to the fuel pump 12 for reforming. When the combustion starts in the combustion unit 20, necessary energy is accumulated and hence the output of the fuel pump 12 for reforming is reduced gradually to control the combustion.

At S16, successively, the conditions are maintained until the flow rate at the fuel pump 12 for reforming comes to 1 L/min (No in step S16). When the flow rate becomes lower than 1 L/min (Yes in step S16), the flow advances to the step S17 where a command to drive the fuel pump 11 for combustion is issued. Then, a command to stop the fuel pump 12 for reforming is issued in step S18. A command to close the second shutoff valve 15 is issued in step S19. A command to open the first shutoff valve 16 is issued in step S20. The fuel pump 12 for reforming is activated again in step S21, thereby starting the supply of fuel to the reforming unit 21. Thereafter, the flow goes to the sequence of the electric power generation in step S22.

The state corresponds to the second flow channel configuration shown in FIG. 3, and the fuel is supplied by the fuel pump 11 for combustion and the fuel pump 12 for reforming to the combustion unit 20 and the reforming unit 21, respectively.

Because of the above configuration, the fuel cell system pump control method and the control unit according to the present embodiment show the following functions and effects.

The flow channels can be switched between for the system start and for the normal operation by use of the bypass line 19 and a pump to be used can be selected. This makes it possible to feed fuel to the combustion unit 20 by the fuel pump 12 for reforming having a large discharge capacity at system start-up and to feed fuel to the combustion unit 20 by the fuel pump 11 for combustion having a small discharge capacity during normal operation, so that a necessary amount of fuel can be supplied stably.

Consequently, even where generated electricity is low during normal operation that has heretofore been a problem, it has become possible to stably send fuel, improve the fuel efficiency, and lower the emission.

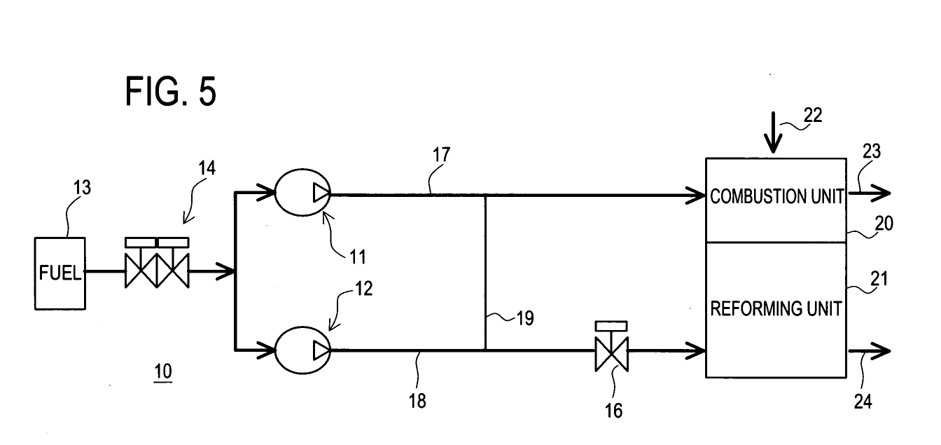

A second embodiment of the present invention is explained referring to FIG. 5. The configuration shown in FIG. 5 is almost the same as the configuration shown in FIG. 1. Hence the same parts are represented by the same reference numerals, the explanations thereof are omitted, and only the different parts are explained. The difference from the configuration shown in FIG. 1 is that the second shutoff valve 15 is not installed in the bypass line 19.

To be specific, even where only the bypass line 19 is installed without the second shutoff valve 15, an arbitrary amount of fuel can be supplied from the second fuel line 18 to the first fuel line 17 by mounting pressure sensors not shown in the first fuel line 17 and the second fuel line 18 and feeding back the pressure values of the two lines respectively. In general, the flow rate of a fluid is determined by pressure difference in accordance with the Bernoulli equation. Accordingly, an orifice of a predetermined area is provided in the bypass line 19, so that the amount of fuel to be supplied from the second fuel line to the first fuel line can be controlled by calculating the flow rate from the pressure difference between the second fuel line 18 and the first fuel line 17 and multiplying the resultant flow rate by the area of the orifice.

The second embodiment has the advantage that the second shutoff valve 15 is eliminated.

Further, even when the pressure sensors are not installed, an orifice having a prescribed aperture area has only to be provided in the bypass line 19. At the start where the first shutoff valve 16 is closed, accordingly, it is possible to supply a large amount of fuel in response to driving of both the first fuel pump and the second fuel pump. During operation where the first shutoff valve 16 is opened, it is possible to supply fuel by the second fuel pump and a predetermined amount of fuel to the first fuel line.

As stated above, the following effects are realized with the reformer shown in the first and second embodiments.

(1) The reforming unit 21 to reform supplied fuel to generate hydrogen, the combustion unit 20 to combust the supplied fuel to heat the reforming unit 21, the first fuel pump 11 to compress and supply fuel to the first fuel line 17 to feed the fuel to the combustion unit 20, the second fuel pump 12 to compress and supply the fuel to a second fuel line 18 to supply the fuel to the reforming unit 21, and the bypass line 19 which brings the first fuel line 17 into communication with the second fuel line 18 are provided. It is therefore possible to complement the poor capacity of a pump by increasing the output of the other pump having a reserve capacity when the other pump has the reserve capacity. This makes it possible to supply a large amount of fuel by the second fuel pump at system start-up and to supply a small amount of fuel by the first fuel pump during normal operation.

Consequently, the excellent effect that only required amount of fuel can always be supplied to the combustion unit is obtained.

Further, the second fuel pump is originally used for supplying fuel to the fuel reforming unit. Hence, a bypass line has only to be added to supply a required amount of fuel without such a large additional cost as incurred in the addition of a new pump.

(2) Further, the supply capacity of the first fuel pump 11 is smaller than the supply capacity of the second fuel pump 12. Thus, the supply capacity of the first fuel pump can be reduced.

(3) Furthermore, since the second shutoff valve 15 is installed in the bypass line 19, the first fuel line can be disconnected from the second fuel line. This makes it possible to control each of the pumps without the influence of the other pump during operation. Further, it is not necessary to accurately control the first fuel pump 11 and the second fuel pump 12 and hence the control unit can be simplified.

(4) Yet further, the first fuel pump 11 has a fuel supply capability that allows a minimum amount of fuel required at the combustion unit 20 to be stably supplied when the fuel is reformed at the reforming unit 21. The second fuel pump 12 has a fuel supply capability that allows a maximum amount of fuel required at the reforming unit 21 to be stably supplied when the fuel is reformed at the reforming unit 21. As a result, it is possible to lower the supply capacity of the first pump to the fuel supply level that allows a minimum amount of fuel required at the combustion unit to be stably supplied when the fuel is reformed at the reforming unit.

In addition, at system start-up, fuel is not required to be supplied to the reforming unit and thus the first fuel pump is used to supply fuel necessary for the primary combustion. During normal operation, the second pump is used to supply fuel required for continuous operation. Thus, the system can be operated stably. It is further possible to supply an optimum amount of fuel to the reforming unit and the combustion unit stably.

As mentioned above, the method for controlling the pump in the fuel cell system method and the control unit according to the present embodiments can exhibit the following excellent effects.

(5) In the method for controlling the pump in the fuel cell system, the system includes the reforming unit 21 to produce hydrogen from fuel, the combustion unit 20 to heat the reforming unit 21, the first fuel pump 11 connected to the combustion unit 20 via the first fuel line 17 and used for supplying the fuel to the combustion unit 20, the second fuel pump 12 connected to the reforming unit 21 via the second fuel line 18 and used for supplying the fuel to the reforming unit 21, and the first shutoff valve 16 installed in the second fuel line 18 and connected to a point between the reforming unit 21 and the second fuel pump 12. The bypass line 19 for connecting the first fuel line 17 to a position in the second fuel line 18 between the first shutoff valve 16 and the second fuel pump 12 is further provided. The supply capacity of the first fuel pump 11 is smaller than the supply capacity of the second fuel pump 12. At system start-up, a system start step is executed by closing the first shutoff valve 16 and supplying the fuel to the combustion unit 20 through the bypass line 19 by the second fuel pump 12. During operation of the system, a system operation step is executed by opening the first shutoff valve. It is accordingly possible to supply a large amount of fuel from the fuel pump 12 for reforming at system start-up and supply a small amount of fuel from the fuel pump 11 for combustion during normal operation.

(6) Additionally, the second shutoff valve 15 is installed in the bypass line 19 so that the second shutoff valve 15 is opened in the system start step and closed at the system operation. Thus, the whole system can optimally be controlled by simple control. Further, the fuel pump 11 for combustion is used to supply an amount of fuel required for primary combustion to the combustion unit 20. The fuel pump 12 for reforming is used during normal operation to supply an amount of fuel necessary for continuous operation to the combustion unit 20. It is consequently possible to stably operate the system.

(7) Yet further, the first fuel pump 11 has a fuel supply capability that allows a minimum amount of fuel required at the combustion unit 20 to be stably supplied when the fuel is reformed at the reforming unit 21. The second fuel pump 12 has a fuel supply capability that allows a maximum amount of fuel required at the reforming unit 21 to be stably supplied when the fuel is reformed at the reforming unit 21. As a result, the supply capacity of the first pump can be lowered to the fuel supply level that allows a minimum amount of fuel required at the combustion unit to be stably supplied when the fuel is reformed at the reforming unit.

In addition, at system start-up, fuel is not required to be supplied to the reforming unit 21 and thus the first fuel pump 11 is used to supply fuel necessary for the primary combustion. During normal operation, the second pump 12 is used to supply fuel required for continuous operation. Thus, the system can be operated stably. It is further possible to supply an optimum amount of fuel to the reforming unit and the combustion unit stably.

The embodiments of the reformer and the fuel cell system gas pump control method according to the present invention are explained above. However the present invention is not limited to those embodiments and any modifications thereof are not excluded as long as the modifications do not depart from the essential characteristics of the present invention.

For example, although the capacity of the fuel pump 11 for combustion is set at 1 L/min and the capacity of the fuel pump 12 for reforming is set at 5 L/min in the embodiments, the capacities are to be changed in accordance with the capacity of a fuel cell. The present invention may be changed in the pump capacities in the combination of pumps that allows fuel to be stably supplied to the combustion unit 20 and the reforming unit 21.

Further, although the explanations have been made on the basis of natural gas, propane gas may be adopted and, in the case of the invention wherein the bypass line 19 is installed, overall hydrocarbon type fuel such as methanol and the like may also be adopted.

1. A reformer comprising:
a reforming unit for reforming fuel supplied thereto to generate hydrogen;
a combustion unit for combusting fuel supplied thereto to heat the reforming unit;
a first fuel pump for compressing and supplying fuel to a first fuel line through which the fuel is to be supplied to the combustion unit;
a second fuel pump for compressing and supplying fuel to a second fuel line through which the fuel is to be supplied to the reforming unit; and
a bypass line that brings the first fuel line into communication with the second fuel line.

2. The reformer set forth in claim 1, wherein
the first fuel pump has a supply capacity smaller than that of the second fuel pump.

3. The reformer set forth in claim 2, wherein the bypass line includes a shutoff valve.

4. The reformer set forth in claim 3, wherein
the first fuel pump has a fuel supply capability that allows a minimum amount of fuel required at the combustion unit to be stably supplied when the fuel is reformed at the reforming unit, and
the second fuel pump has a fuel supply capability that allows a maximum amount of fuel required at the reforming unit to be stably supplied when the fuel is reformed at the reforming unit.

5. A method for controlling a pump in a fuel cell system comprising:
a reforming unit for generating hydrogen from fuel;
a combustion unit for combusting the reforming unit;
a first fuel pump connected to the combustion unit through a first fuel line, the pump being used for supplying the fuel to the combustion unit;
a second fuel pump connected to the reforming unit through a second fuel line, the pump being used for supplying the fuel to the reforming unit; and
a first shutoff valve connected to a point of the second fuel line between the reforming unit and the second fuel pump,
wherein the system further comprises a bypass line that connects a point of the second fuel line between the first shutoff valve and the second fuel pump to the first fuel line,
the method comprises a system start step of closing the first shutoff valve and supplying the fuel to the combustion unit through the bypass line by the second fuel pump at system start-up, and
a system operation step of opening the first shutoff valve during operation.

6. The method for controlling a pump in a fuel cell system set forth in claim 5, wherein
the bypass line is provided with a second shutoff valve, and
the system start step includes opening the second shutoff valve and the system operation step includes closing the second shutoff valve.

7. The method for controlling a pump in a fuel cell system set forth in claim 5, wherein
the first fuel pump has a fuel supply capability that allows a minimum amount of fuel required at the combustion unit to be stably supplied when the fuel is reformed at the reforming unit, and
the second fuel pump has a fuel supply capability that allows a maximum amount of fuel required at the reforming unit to be stably supplied when the fuel is reformed at the reforming unit.

8. A control unit for a pump in a fuel cell system comprising:
a reforming unit for generating hydrogen from fuel;
a combustion unit for combusting the reforming unit;
a first fuel pump connected to the combustion unit through a first fuel line, the pump being used for supplying the fuel to the combustion unit;
a second fuel pump connected to the reforming unit through a second fuel line, the pump being used for supplying the fuel to the reforming unit; and
a first shutoff valve connected to a point of the second fuel line between the reforming unit and the second fuel pump,
wherein the system further comprises a bypass line that connects a point of the second fuel line between the first shutoff valve and the second fuel pump to the first fuel line, and
the first fuel pump has a supply capacity smaller than that of the second fuel pump.

9. The control unit for a pump in a fuel cell system set forth in claim 8, wherein the bypass line includes a second shutoff valve.

10. The control unit for a pump in a fuel cell system set forth in claim 8, wherein
the first fuel pump has a fuel supply capability that allows a minimum amount of fuel required at the combustion unit to be stably supplied when the fuel is reformed at the reforming unit, and
the second fuel pump has a fuel supply capability that allows a maximum amount of fuel required at the reforming unit to be stably supplied when the fuel is reformed at the reforming unit.
